(19) United States
(12) Patent Application Publication
(10) Pub. No.: US 2006/0207592 A1
(43) Pub. Date: Sep. 21, 2006

(54) System and method of active neuro-protection for detecting and arresting traumatic brain injury and spinal cord injury

(76) Inventors: Landon C. G. Miller, Tuscaloosa, AL (US); Jay M. Meythaler, Grosse Pointe Farms, MI (US)

Correspondence Address: GIFFORD, KRASS, GROH, SPRINKLE, ANDERSON &;CITKOWSKI, P.C., P.O. BOX 7021, TROY, MI, 48007-7021, US

(21) Appl. No.: 11/377,000

(22) Filed: Mar. 16, 2006

Related U.S. Application Data
(63) Continuation of application No. 10/530,970.
(60) Provisional application No. 60/417,434, filed on Oct. 10, 2002.

(51) Int. Cl. A62B 7/00

(52) U.S. Cl. 128/200.24

(57) ABSTRACT

A system and method of active neuro-protection for detecting and arresting injury to an individual is provided. The system includes a sensing means for sensing the occurrence of a predetermined event within an environment and for operatively transmitting an event indicating signal. The system also includes a controller operatively in communication with the sensing means including a processor for processing the event indicating signal to determine if a predetermined condition is met for releasing a neuro-protective agent. The system further includes a dispensing means for releasing the neuro-protective drug, and the dispensing means is operatively in communication with the controller, and releases the neuro-protective drug if the controller transmits a drug releasing signal to the dispensing means if the predetermined condition is met. A method includes the steps of monitoring for a predetermined condition that would induce a traumatic injury to an individual within an environment using the sensing means, determining if the predetermined traumatic injury inducing condition is detected by the controller, and dispensing a neuro-protective drug.

### RELATED APPLICATION

This application claims priority of U.S. Provisional Patent Application Ser. No. 60/417,434 filed Oct. 10, 2002, which is incorporated herein by reference.

### FIELD OF THE INVENTION

The subject invention relates to traumatic central nervous system injury and, more particularly, to a system and method of active neuro-protection for detecting and arresting brain injury and/or spinal cord injury as a result of a trauma.

### BACKGROUND OF THE INVENTION

Traumatic brain injury (TBI) occurs as the result of an application of a force to the brain of an individual which distorts brain tissue due to the rapid motions which occur. Frequently referred to as a closed head injury, early detection is critical to arresting further injury after the initial injury. There are five main types of traumatic brain injury, including diffuse axonal injury (DAI), contusion, anoxic, hemorrhagic, and perfusion-reperfusion. The predominant mechanism in most cases of traumatic brain injury (TBI) is diffuse axonal injury. While axonal injury is common in all TBI regardless of severity, a shearing of the axons occurs in human diffuse axonal injury (DAI) leading to progressive changes that ultimately may result in the loss of connections between nerve cells. The progression of events in DAI continues from the time of injury to several weeks after injury, thus creating several windows of opportunity for therapeutic intervention.

There are approximately 500,000 new cases of TBI in the U.S. each year, and the incidence requiring hospitalization is estimated to be approximately 200-225/100,000 population. Currently, it is estimated that brain injuries account for over 10% of all hospital admissions in the United States. When compared to spinal cord injury, which accounts for less than 1% of hospital admissions, it is clear that TBI is a medical care problem which has a significant impact financially within the United States.

Over 50,000 people die each year from TBI, resulting in direct costs approximated at more than $50 billion annually. The costs of severe TBI to the individual and family are extremely high. About one-half of all TBIs are transportation related and these patients have some of the highest combined charges for acute care and rehabilitations. This may be related to the mechanism of TBI in high-speed motor vehicle crashes, specifically the presence of diffuse axonal injury (DAI) being most prevalent in the midbrain and brain stem areas. Clearly, brain injuries of this severity that occur with high-speed acceleration-deceleration injuries, have the highest costs to society.

The predominant mechanism of injury in a high-speed motor vehicle crash is considered to be diffuse axonal injury (DAI). It has also been shown that based on beta-amyloid precursor protein immunostaining, axonal injury may be present in all cases of fatal head injury. In cases of persistent vegetative states, evidence of DAI in magnetic resonance imaging (MRI) has recently been observed. Diffuse axonal injury occurs even in the absence of a blow to the head and is more prevalent than previously realized. Even in mild head injury, diffuse axonal injury is present in almost one-third of the cases. The defining characteristic of DAI is the morphologic change to the axons which occurs over the course of several days to weeks and the fact that multiple regions of the brain are injured. While a component of DAI is present in blunt or penetrating trauma injury, it is at the periphery of the injury zone and is much less significant than the predominant mechanism of injury. DAI is the major mechanism of injury in high-speed acceleration-deceleration injuries associated with motor vehicle crashes. While all four mechanisms of TBI (DAI, blunt trauma, penetrating trauma, axonia) may be involved in such an injury, it is the predominant mechanism of injury under this condition.

Diffuse axonal injury is only one of the cellular mechanisms of traumatic brain injury. The others include such things as direct contusion to the cells, intracerebral hemorrhage (blood across the blood brain barrier), perfusion-reperfusion injury, and anoxia. In a high velocity TBI, such as those sustained in a car accident and the subsequent sequelae, one can have several mechanisms of cellular injury. Each of these mechanisms appears to cause a unique area and type of TBL. This also indicates that each type of cellular injury activates different cellular pathways and cellular channels.

In DAI, when enough force is applied to the cytoplasm of the neuronal cell, the elastic memory of the substance is exceeded. Then the amount of cytoplasmic deformation is directly related to the time the force is applied. This in turn relates to the amount of cytoskeletal disruption that occurs. Studies have indicated that the severity of neuronal injury that occurs when a rat is injured at a defined Hertz is related to the length of time the force is applied. Furthermore, many of the same areas of the brain have cellular disruption (corpus callosum, mesencephalon and brain stem) as is noted in humans who have suffered high velocity TBI in motor vehicle crashes. It is understood that many who have suffered a TBI in a cause similar to a motor vehicle crash may have more than one mechanism of neural cell injury. In U.S. patent application Ser. No. 09/913,017 entitled “Apparatus for Simulating Traumatic Brain Injury and Method for Inducing Spinal Cord Injury”, which is incorporated herein by reference, the causes and the subsequent effects of DAI on neuronal cells are analyzed and unique compounds are tested to protect against further neural cell death and injury without any of the other confounding, and many times masking, causes of neural cell injury being involved. In the model described in U.S. patent application Ser. No. 09/913,017, the cellular disruption was not accompanied by intracerebral hemorrhage or contusion, and does not involve primarily perfusion-reperfusion or anoxic injury to the neuronal cells. By limiting the type of injury to a single type, the mechanism of injury was studied, and its biochemical interactions and unique compounds to protect against neural cell injury. The foundation of this patent is its isolation of this single injury type, and the subsequently derived methods of testing for mitigation, methods of investigative research, and methods of treatment based on this uniquely isolated injury type. This is also important because DAI is, in many cases, especially in auto and other inertia caused injuries, the predominate injury type.

Many of the areas that are injured in DAI are contiguous to the areas of cerebrospinal fluid (CSF) circulation in the brain. They are thus readily accessible to treatment via diffusion with substances delivered into the CSF for circulation and such diffusion into the injured areas.

Based on studies of head injury in primates (including man), some of the mechanical forces which bring about DAI have been elucidated. The crucial factors are (1) the type of acceleration/deceleration (angular rather than translational), (2) the duration of acceleration/deceleration (long rather than short), and (3) the direction of head movement (coronal rather than sagittal). Clearly, angular acceleration or the associated sudden deceleration associated with all “impact” will create forces above the threshold level. Similarly, most, but not all shaken baby syndromes are characterized by a sudden deceleration.

Current research appears to point of plastic deformation within and of the axons that leads to the predominant cause of injury. The elastic tissues of the brain have plastic properties. Once the level of force is applied to a plastic substance, it is the time period over which it is applied that causes the amount of deformation. If the elastic memory of the substance is exceeded, then there will be shearing and tearing. The high-speed motor vehicle accident with deceleration lasting more than one to three seconds or several seconds of repetitive shaking can produce enough force for this to happen.

Research suggests that once the amount of force has reached a threshold, it is the length of time the force is applied with the associated plastic deformation that is the predominant factor which causes the intracellular damage to the organelles within the axon. Hence, there is a continuum over which DAI occurs in TBI. After the threshold of necessary force to create plastic deformation is reached, it may be the length of time over which it is applied that determines the amount of DAI. Unfortunately, most TBI occurs over several seconds (high-speed transportation crashes) where DAI is likely to be the predominant method of injury. This is supported by the fact that many severe TBI patients have minimal changes noted on CT scan following motor vehicle crashes.

For many years, DAI has been known to be associated with a coma of immediate onset after brain injury, but the diagnosis could only be established by autopsy. Indeed, the clinical syndrome of coma without any preceding lucid interval, decerebration, and autonomic dysfunction were often ascribed to primary brainstem injury. However, it is now clear that primary brainstem lesions do not occur in isolation but rather in association with DAI and usually involve the cerebral hemispheres and cerebellum in addition to the brainstem. Evidence of the mechanism of injury can be elicited by pathological studies of patients killed from high-speed transportation injuries as well as pathological studies of “shaken baby syndrome,” a distinct subset of DAI. It has been suggested that this shaking mechanism of DAI injury also applies to adults. The injury is characterized by specific neuropathological findings. On CT and MRI, this usually involves hemorrhagic punctate lesion of the corpus callosum, pontine-mesencephalic junction adjacent to the superior cerebellar peduncles and diffuse axonal damage in the white matter of the brain, brainstem and cerebellum which begin to atrophy within two weeks after injury.

Diffuse axonal injury in humans is characterized by widespread damage to axons in the cerebral hemispheres, the cerebellum and the brain stem and is a consistent feature of TBI. The probable physical and physiologic mechanism that results in medical and neurophysiologic complication of DAI are discussed in “Current Concepts: Diffuse Axonal Injury-Associated Traumatic Brain Injury”, Meythaler et al., Arch. Phys. Med. Rehabil. Vol. 82, October 2001. The histologic features of DAI are directly related to the length of time elapsed since the onset of injury. It has been shown that there is evidence of damage to axons in the form of axonal bulbs about twenty-four hours after the injury. It is believed that DAI is caused by both primary asotomy from mechanical forces at the time of injury and secondary asotomy from biochemical factors. The microscopic features correspond to Wallerian-type axonal degeneration. There is a slow progression from axonal swelling to axonal bulbs, to the development of small clusters of microglia throughout the parasagittal white matter, the corpus callosum, the internal capsule and the deep gray matter. This progression can continue for months to years after the original injury. While many of the damaged neurons may survive, it may take a long period of time for them to be restored to their normal physiologic function, including action potential propagation. In the first two years after DAI, there is active myelin degeneration, the final stage of the injury process. As a result of the traumatic injury to the axons, the neural activity at that site is compromised, which is assumed to be a factor in resultant morbidity.

A characteristic feature of DAI is a prolonged progression of secondary events that may result in axonotmesis, which is the interruption of the axon of a nerve followed by complete degrigation of the distal segment. After an injury, there is a depolarization followed by a focal loss of axonal transport resulting from the disruption of the cellular organelles. One consequence of DAI is direct intracellular injury from direct mechanical displacement of the cytoskeleton and cytoplasm. The cascade of biochemical events subsequent to the TBI is thought to lead to further neuronal cell injury and axonotmesis. This sequence of events includes the depletion of adenosine 5′-triphosphate (ATP), intracellular calcium overload, and the production of strong oxidants, resulting in oxidative stress. The injury to the mitochondria results in a decrease in the local production of ATP within the cell. Without ATP, the ion pumps that maintain Na+, K+ and Ca++ homeostasis within the axon begin to fail. While the immediate effect of a TBI may be both cell death and cell injury, the injured cells may be pushed over the edge to cell death by secondary biochemical factors that tend to increase the influx of calcium into the cell. This cascading injury cycle repeats itself as the calcium-sodium influx reached a critical level in the adjacent cells, resulting in additional cellular necrosis and apoptosis over time. Clinical findings indicate that DAI not be apparent initially after injury using known diagnostic techniques, such as CT and MRI scans, but is evident at a later time.

Neuroprotective agents are drugs which can arrest the previously described damage that occurs to the brain and/or spinal cord as a result of an injury to the brain. In the past, the neuroprotective drugs were administered to the injured individual after the occurrence of the injury, using traditional medical processes, such as by emergency personnel or in a hospital setting. The delay in administering the neuroprotective agent limits the ability of such drugs to prevent and/or reduce the effects of such an injury.

Thus, there is a need in the art for a system and method of detecting and arresting the biochemical changes occurring within the axon using a neuro-protective drug, as a result of a traumatic brain injury, to slow down or curtail the effect of the cascading injury cycle on the cells.

### SUMMARY OF THE INVENTION

Accordingly, a system and method of active neuro-protection for detecting and arresting injury to an individual is provided. The system includes a sensing means for sensing the occurrence of a predetermined event within an environment and for operatively transmitting an event indicating signal. The system also includes a controller operatively in communication with the sensing means including a processor for processing the event indicating signal to determine if a predetermined condition is met for releasing a neuro-protective agent. The system further includes a dispensing means for releasing the neuro-protective drug, and the dispensing means is operatively in communication with the controller, and releases the neuro-protective drug if the controller transmits a drug releasing signal to the dispensing means if the predetermined condition is met.

The method includes the steps of monitoring for a predetermined condition that would induce a traumatic injury to an individual using the sensing mechanism, determining if the predetermined traumatic injury inducing condition is detected by the controller, and dispensing a neuro-protective drug from a dispensing means operatively in communication with the controller if the predetermined traumatic injury inducing condition is detected.

One advantage of the present invention is that a system and method of active neuro-protection is provided that detects and arrests or slows down the injury cycle within the central nervous system of the human body resulting from a TBI. Another advantage of the present invention is that a system and method is provided that disperses a neuro-protective drug concurrent with the occurrence of an injury. Still another advantage of the present invention is that a system and method is provided that senses a predetermined TBI condition and immediately disperses a neuro-protective drug. Yet another advantage of the present invention is that a system and method is provided for reducing the severity of injury and improving the prognosis for recovery utilizing a non-invasive method for quickly delivering a neuroprotective drug to the brain and spinal cord. A further advantage of the present invention is that a system and method is provided for minimizing damage resulting from secondary injury to the brain that occurs after the initial traumatic injury. Still a further advantage of the present invention is that a system and method is provided that reduces cost, both short term and long term, associated with recovery from such an injury. Yet still a further advantage of the present invention is that a system and method is provided for automatically sensing a traumatic brain injury and delivering a drug internasally during the occurrence of the injury to minimize damage. Yet a further advantage of the present invention is that the system for automatically sensing a traumatic brain injury can be incorporated in another protective device such as a headgear, or a seat or the like due to its size and portability.

Other features and advantages of the present invention will be readily appreciated, as the same becomes better understood after reading the subsequent description taken in conjunction with the accompanying drawings.

### BRIEF DESCRIPTION OF THE DRAWINGS

FIG. 1 is a block diagram of a system of active neuro-protection for arresting traumatic brain injury and spinal cord injury, according to the present invention;

FIGS. 2-5 are examples of environments for using the system of FIG. 1, according to the present invention; and

FIG. 6 is a flowchart of a method of active neuro-protection for arresting traumatic brain injury and spinal cord injury using the system of FIG. 1, according to the present invention.

### DETAILED DESCRIPTION OF THE INVENTfON

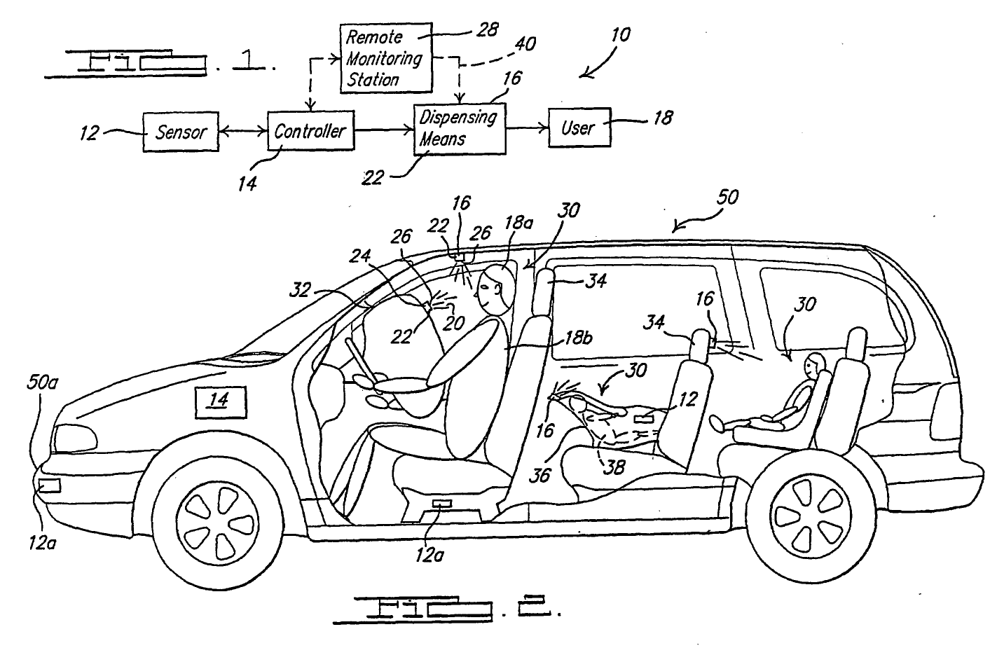

Referring to FIG. 1, a block diagram of a system of active neuro-protection which affects the brain of an individual is generally shown at 10. Active neuro-protection is utilized to sense and arrest or slow down the traumatic brain and/or spinal cord injury cycle within a predefined time period, such as while the injury is occurring, or for a predetermined period of time thereafter, or the like. The system benefits a user or individual 18 who receives the neuro-protective drug to arrest the cascading injury cycle within the brain or spinal cord as a result of a traumatic injury.

The system 10 includes a sensing mechanism 12 for sensing the occurrence of a trauma-inducing event. There are a multitude of environments in which an event may occur that results in the transmission of forces, including but not limited to acceleration and deceleration forces, to the brain 18a of an individual 18 over a period of time. One example of an event is a transportation-related injury involving a vehicle, such as a passenger car, truck, sports utility vehicle, airplane, train, spacecraft, motorcycle, bicycle, boat or the like. Another example of an event is a sports-related injury involving a sport such as football, soccer, hockey, baseball or the like. Other examples of events include activities where it is foreseeable that the possibility exists of sudden or sustained deformitive forces that can result in brain 18a or spinal cord 18b injuries.

Various types of sensing mechanisms 12 are contemplated, depending on the environment and the force being measured. An example of a sensing mechanism 12 is a force sensing mechanism 12c. One type of force sensing mechanism is a strain gauge. Another type of force sensing mechanism is a motion sensor, such as an accelerometer or decelerometer, which is capable of converting motion or force applied thereto into an electrical signal or output. An example of a motion sensor is a 6-gimbel force sensor.

Preferably, the sensing mechanism 12 is positioned in the environment in order to ascertain readings or measurements in the vicinity of particular regions of the brain 18a or spinal cord 18b. It should be appreciated that closed-loop analysis can be utilized to analyze force levels by periodically measuring the actual forces and comparing the actual force level to a predefined normative force level. Additionally, deformative forces can be periodically measured and compared against the normative forces. In a preferred embodiment of the present invention, a plurality of force sensing mechanisms 12 are utilized in order to obtain accurate information regarding the forces applied to the brain or spinal cord.

A further example of a sensing mechanism 12 is a biological agent sensor 12b for sensing the presence of a biological agent, such as nerve gas or anthrax or the like. Various other sensing mechanism are contemplated, depending on the circumstance for which active neuroprotection is desired. One characteristic of the sensing mechanism is that it rapidly detect and identify a force and energy level that would cause a contusive brain injury or diffuse axonal injury. One example of such device for selectively injuring a rat in such a manner so as to mimimic a diffuse axonal injury is disclosed in U.S. Pat. No. 6,588,431 to Meythaler et al., which is incorporated herein by reference.

The system 10 also includes a controller 14 operatively in communication with the sensing mechanism 12. The controller 14 receives and processes the information generated by the sensing mechanism 12. The controller 14 may include a microprocessor having a memory and a processor, as is known in the art. The controller 14 is preferably positioned near, or integral with, the sensing mechanism 12.

The system 10 also includes a non-invasive drug dispensing means 16 for dispersing a neuro-protective drug to the individual 18. The drug dispensing means 16 is operatively in communication with the controller 14, and dispenses the drug 20 upon the receipt of a predetermined signal from the controller 14. It is contemplated that the individual 18 will inhale an airborne drug reflexively during the occurrence of a traumatic event, so that the individual 18 immediately benefits from the neuro-protective effect of the drug.

Various classifications of neuro-protective drugs 20 are contemplated. Preferably, the neuro-protectors are classified according to their function at a predetermined point in time in the injury cycle, and the clinical indications of the individual at that point in time. These classifications may include immediate, near term and long term neuro-protective drugs. Examples, of neuro-protective drugs include Hypothermia; Enoxaporin; Nrf-1 transcriptase factor, Nrf-2 transcriptase factor, CyclosporineA #19, #22, #67, #84, #90, #104, #118, #68; Creatine #69; CP-101,606 #81; Dizocilpine #134; and Nimodipine #10. Another example of a neuroprotective drug is a GABAmide, a perfect GABA agonist, which is disclosed in U.S. patent application Ser. No. 10/049,328 filed Feb. 11, 2002 (Meythaler et al.), which is incorporated herein by reference.

It should be appreciated that the neuro-protective drug 20 is dispersible in various forms, depending on the dispensing means 16, such as a mist, a liquid or a powder, or the like.

The dispensing means 16 includes a storage receptacle 22 for storing the neuro-protective drug. The storage receptacle 22 stores a predetermined dosage of the drug 20, which is dependent on the use contemplated for the system. It should also be appreciated that the dispensing means 16 may include a refillable storage receptacle. In addition, the storage receptacle 22 may also include an indicating means 24 for indicating to a user if the storage receptacle should be refilled with the neuro-protective drug.

The dispensing means 16 also includes a non-invasive neuro-protective drug releasing means 26 for dispensing the drug from the storage receptacle. Preferably, the dosage of the neuro-protective drug is tailored to a particular environment. One example of a releasing means 26 is an airborne dispensing mechanism, such as an aerosol for providing the neuro-protective drug as a mist that is inhaled by the individual. Advantageously, the dispensing means 16 is positioned near the nose of the individual, so that the individual inhales the neuro-protective drug 20 as part of the human body's shock response reflex.

The drug releasing means 26 may also include a propellant or the like to forcibly dispense the neuro-protective drug quickly and efficiently to the individual. It is contemplated that the propellant may include explosive properties to expel the liquid while atomizing the liquid, without affecting the chemical properties of the neuro-protective drug or without further injury to the individual.

In still another embodiment, the dispensing means 16 is an invasive dispensing means. For example, the dispensing means 16 is a needle for injecting the neuro-protective drug directly into the bloodstream of the individual. This mechanism is advantageous when placement near the nose is not possible, or inhalation is not an expected response, or in an open-air type environment

It should be appreciated that other examples of dispensing means 16 are contemplated, depending on the environment within which the system is implemented.

The sensing mechanism 12, controller 14 and dispensing means 16 are operatively in communications with each other using a wired or a wireless communication means. For example, each mechanism may contain a transceiver for transmitting and/or receiving a signal 40. One example of such a signal 40 is a radio frequency or RF signal, as is understood in the art.

In another alternative embodiment, the system includes a remote monitoring station 28 for remotely monitoring the individual 18 and the individual's environment 30. Advantageously, the remote monitoring station 28 causes the dispensing means 16 to dispense the neuroprotective drug 20 in situations where additional safeguards are desirable. The remote monitoring station 28 is operatively in communication with the controller 14, and monitors the output from the sensing mechanism 12. The remote monitoring station 28 signals the controller 14 to activate the drug releasing means 26 to release the neuro-protective drug 20 from the storage receptacle 22, upon the occurrence of a predetermined condition. An example of predetermined condition is if a force within the environment 30 exceeds a predetermined value. Another example of a predetermined condition is if a predetermined chemical agent is sensed within the environment 30 of the individual. An example of a predetermined chemical agent is a nerve gas, anthrax, or another biological warfare agent or the like. The remote monitoring system may operatively be in communication with the controller 14, or sensing mechanism 12 or dispensing means as previously described, or using another signal transmitting means, such as over the Internet.

It should be appreciated that the sensing mechanism 12, dispensing means 16 and control means 10 may be integrally contained within a housing. The packaging of the system is dependent on the environment 30, as will be discussed.

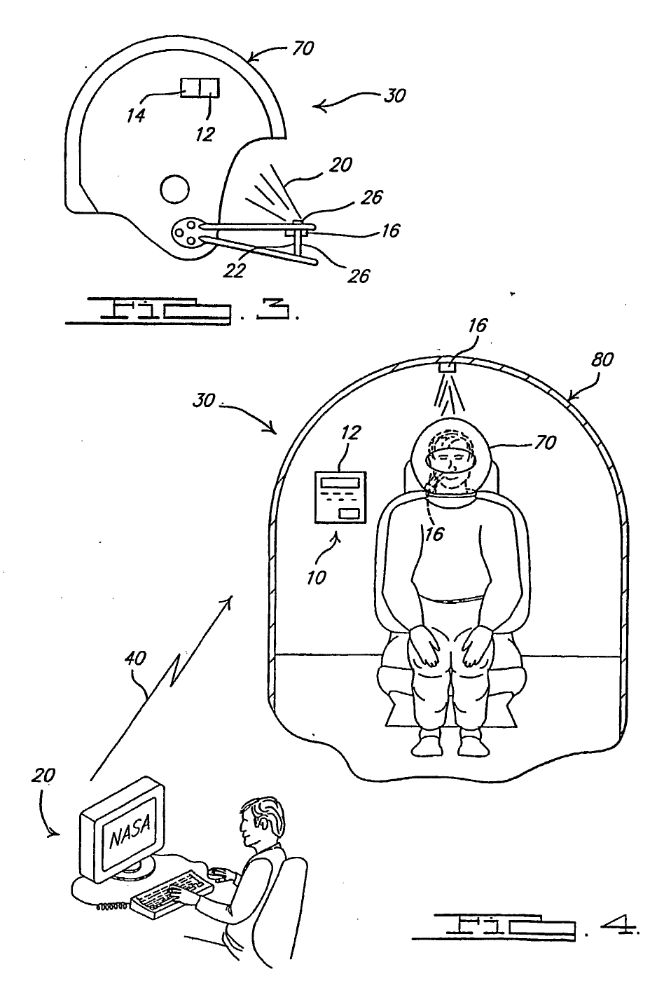

Referring to FIGS. 2 through 5, various examples of environments 30 utilizing the previously described system are illustrated. It should be appreciated that these examples of environments 30 are merely illustrative of the types of environment 30 that may benefit from the system 10 of the present invention, and other environments 30 are certainly contemplated. FIG. 2 illustrates an environment 30 of a vehicle 50, which in this example is a motor vehicle, such as a van. It is contemplated that the vehicle 50 can contain one or more active neuro-protective systems 10. For example, the vehicle 50 may contain a sensing mechanism 12 in the vehicle bumper 50a that senses a force from a frontal impact to the vehicle 50, and the sensing mechanism 12 is in communication with a controller 14. If a frontal impact is sensed, the controller 12 activates an air bag system 32. The dispensing means 16 may be integral with the air bag 32, and releases the neuro-protective drug 20 as a mist as the air bag 32 is deployed. The individual 18 breathes in the mist containing the neuro-protective drug 20.

In another example, the sensing mechanism 12 is located within a seat, 34 of the vehicle 50, and the dispensing means 16 is positioned in the vehicle 50 so that it is near the nose of the individual 18 for involuntary inhalation of the drug by the individual 18. For example, the dispensing means 16 is positioned in the headliner or seat 34 of the vehicle 50.

In still another example, the sensing mechanism 12, dispensing means 16 and controller 14 are integrally contained within a child protective seat 36. Preferably, the dispensing means 16 is positioned near the nostrils of a child 38 strapped into the seat.

Referring to FIG. 3, the environment 30 is a protective headgear 70, such as that worn by a pilot, a race car driver, a motorcyclist, a football player or other sport, or an astronaut or the like. Preferably, the dispensing means 16, sensing mechanism 12 and controller 14 are integrally contained within the protective headgear 70. The dispersing means 16 is advantageously located in a proximate location to the individual's nostrils. In operation, the sensing mechanism 12 senses a predetermined condition, such as a force delivered to the head, and the controller 14 instructs the dispensing means to dispense the neuro-protective drug 20 to arrest the injury to nerve cells within the brain 18a of the individual.

Referring to FIG. 4, another example of an environment 30 within a spacecraft 80 is illustrated. The active neuro-protective system 10 is packaged within the protective headgear 70 worn as part of the astronaut's space uniform. Alternatively, the active neuro-protection system 10, i.e. a sensing mechanism 12, controller 14 and dispensing mechanism, are disposed in the space vehicle.

In an alternative embodiment, the remote monitoring station 28 monitors the signal from the sensing mechanism 12, and automatically sends a signal to the controller 14 to activate the dispensing means 16 if a predetermined condition is met based on a signal from the sensing mechanism 12. It is contemplated that the dispensing means 16 can be of the noninvasive or invasive type.

Referring to FIG. 5, a further example of an environment 30 is illustrated. In this example, the environment 30 is an open area, such as a battlefield or the like, and the individual 18 is a soldier or other such person within the environment. The environment 30 may be locally or remotely monitored for a predetermined condition using a sensing mechanism 12. The remote monitor 28 automatically transmits a signal 40 to a controller in communication with a body mounted dispensing mechanism 92. In this example, the body mounted dispersal mechanism 92 is disposed within a watch. The neuro-protective drug 20 is automatically injected into the bloodstream of the individual 18 if a predetermined condition is met. An example of a predetermined condition is if a hazardous chemical or biological material, such as nerve gas or anthrax, is detected. Alternatively, the sensing mechanism and dispensing mechanism are both disposed in the body-supported device. The system, including the body supported device 92, sensor 12 or remote monitoring station may also contain a transceiver for transmitting and/or receiving a signal 40. One example of such a signal 40 is a radio frequency or RF signal, as is understood in the art.

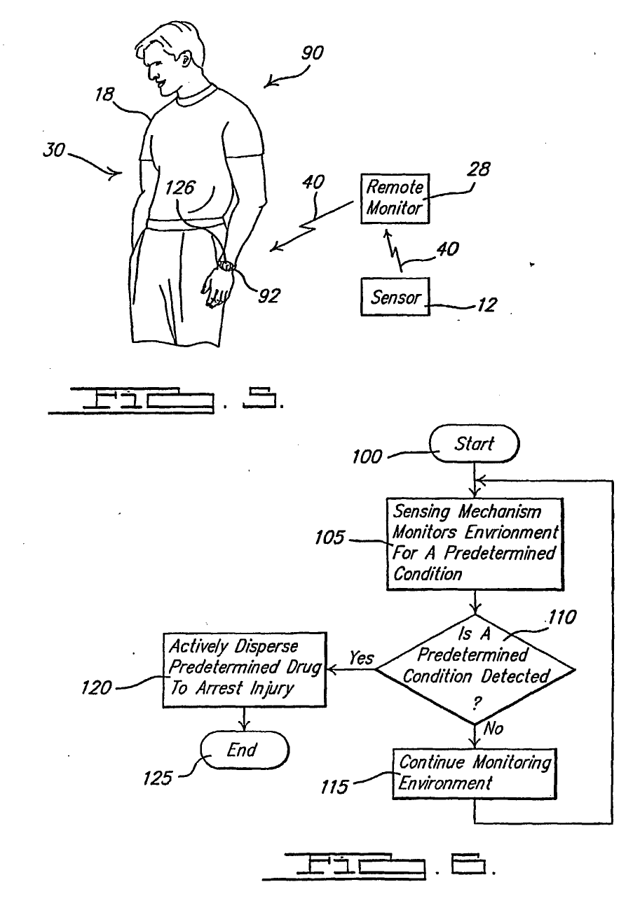

Referring to FIG. 6, an example of a methodology of active neuro-protection is described for use with the previously described system 10. The method begins in block 100 and continues to block 105. In block 105, the sensing mechanism 12 monitors the environment 30 in real time in order to detect the occurrence of a predetermined condition. Preferably, the monitoring is ongoing, in order that the system 10 responds quickly upon the occurrence of a traumatic event. An example of a predetermined condition is a predetermined level of force directed towards the central nervous system, including the brain 18a and/or spinal cord 18b, of the individual 18. Another example of a predetermined condition is the presence of a predetermined environmental material, such as a hazardous chemical or biological agent. Various examples of environments 30 and detection mechanisms were previously described with respect to FIGS. 1-5, and other examples are contemplated. The methodology advances to diamond 110.

In diamond 110, the methodology determines if the predetermined condition is detected. For example, an event signal 40 is transmitted from the sensing mechanism 12 to the controller 14. The controller 14 compares the event indicating signal to a predetermined threshold condition. As previously described, the threshold condition can be a force level, or an environmental quality level or the like. If the predetermined condition is not detected, the methodology advances to block 115 and continues to monitor the environment 30. The methodology advances to block 105 and continues.

Returning to block 110, if the predetermined condition is detected, the methodology advances to block 120. In block 120, the controller transmits a drug releasing signal 40 to the dispensing mechanism 16, and the dispensing mechanism 16 actively disperses the predetermined neuro-protective drug 20 to the individual to arrest injury to the central nervous system of the individual. It should be appreciated that the neuro-protective drug 20 is expelled quickly, so that the individual 18 receives its benefit as the injury is occurring, or shortly thereafter, to minimize injury to the brain 18a and/or spinal cord 18b. Advantageously, the dispersal of the drug 20 is automatic, that is, it is not controlled by the individual 18 and the individual 18 receives the neuro-protective drug regardless of the physical condition of the individual 18.

The methodology advances to circle 125 and ends.

It should be appreciated that this method may be used in conjunction with other neuro-protective drug strategies, as part of a comprehensive treatment program of a patient. It is also contemplated that the neuro-protective agent may be dispersed immediately after the injury, as part of an emergency first aid response, or within a hospital as part of a clinical treatment program.

The present invention has been described in an illustrative manner. It is to be understood that the terminology which has been used is intended to be in the nature of words of description rather than of limnitation.

Many modifications and variations of the present invention are possible in light of the above teachings. Therefore, within the scope of the appended claims, the present invention may be practiced other than as specifically described.

1. A system of active neuro-protection for detecting and arresting injury to an individual comprising:
a sensing means for sensing the occurrence of a predetermined event within an environment and for operatively transmitting an event indicating signal;
a controller operatively in communication with said sensing means, wherein said controller includes a processor for processing said event indicating signal to determine if a predetermined condition is met for releasing a neuro-protective agent;
a dispensing means for releasing a neuro-protective drug, wherein said dispensing means is operatively in communication with said controller, and releases said neuro-protective drug if said controller transmits a drug releasing signal to said dispensing means if the predetermined condition is met.

2. A system as set forth in claim 1 wherein said controller is operatively in communication with a remotely located computer monitoring system for remotely monitoring the individual within the environment by receiving an event indicating signal from the sensing mechanism and transmitting a drug releasing signal to the dispensing means to release the neuro-protective drug if the predetermined condition is met.

3. A system as set forth in claim 1 wherein said signal is a radio frequency signal, and said remotely located computer system, said controller, said sensing means and said dispensing means each includes a transceiver for transmitting and receiving the radio frequency signal.

4. A system as set forth in claim 1 wherein said dispensing means releases said neuro-protective drug in an atomized mist that is automatically inhaled by the individual.

5. A system as set forth in claim 1 wherein said dispensing means releases said neuro-protective drug by automatically injecting the neuro-protective drug into the bloodstream of the individual.

6. A system as set forth in claim 5 wherein said dispensing means is contained within a body mounted dispensing mechanism.

7. A system as set forth in claim 1 wherein said sensing means, controller and dispensing means are integrally contained within a housing.

8. A system as set forth in claim 1 wherein said predetermined condition is if a force is exerted on the individual that excceeds a predefined level that would cause injury to the brain and/or spinal cord of the individual.

9. A system as set forth in claim 1 wherein said predetermined condition is a presence of a chemical agent within the environment of the individual that exceeds a predefined level that would cause injury to the brain and/or spinal cord of the individual.

10. A system as set forth in claim 1 wherein the environment is a vehicle, and the dispensing mechanism is positioned near the nose of the individual seated in the vehicle.

11. A system as set forth in claim 1 wherein the environment is a vehicle, and the sensing means is positioned on a vehicle body component, and the dispensing means is positioned within a vehicle seat.

12. A system as set forth in claim 1 wherein the environment is a vehicle, and the sensing means and the dispensing means are integrally disposed within a vehicle seat.

13. A system as set forth in claim 1 wherein said neuro-protective drug is from a class of drugs that functionally arrest injury to the central nervous system of the individual.

14. A system as set forth in claim 1 wherein said sensing means, said controller and said dispensing means are disposed within a protective headgear, and said neuro-protective drug is inhaled by the individual.

15. A method of active neuro-protection for detecting and arresting traumatic injury to the brain and/or spine of an individual, said method comprising the steps of:
monitoring for a predetermined condition that would induce a traumatic injury to an individual within an environment using a sensing means;
determining if the predetermined traumatic injury inducing condition is detected by a controller receiving a signal from the sensing means; and
dispensing a neuro-protective drug from a dispensing means operatively in communication with the controller if the predetermined traumatic injury inducing condition is detected.

16. A method as set forth in claim 15 further including the step of continuing to monitor the environment if the predetermined traumatic injury inducing condition is not detected.

17. A method as set forth in claim 15 wherein said neuro-protective drug is from a class of drugs that functionally arrest injury to the central nervous system of the individual.

18. A method as set forth in claim 15 further including the step of remotely monitoring the individual within the environment using a remotely located computer monitoring system for remotely monitoring the individual within the environment by receiving an event indicating signal from the sensing mechanism and transmitting a drug releasing signal to the dispensing means to release the neuro-protective drug if the predetermined condition is met.

19. A method as set forth in claim 15 further including the step of locating the dispensing mechanism near the nose of the individual so that the individual automatically inhales the released neuro-protective drug.

20. A method as set forth in claim 15 further including the step of locating a body mounted dispensing mechanism on the body of the individual so that the released neuro-protective drug is automatically injected into the body of the individual.

21. A method of active neuro-protection for detecting and arresting traumatic injury to the brain and/or spine of an individual, said method comprising the steps of:
locating a body mounted dispensing mechanism on the body of the individual, wherein the body mounted dispensing mechanism contains a neuro-protective drug from a class of drugs that functionally arrest injury to the central nervous system of the individual;
monitoring for a predetermined condition that would induce a traumatic injury to an individual within an environment using a sensing means;
determining if the predetermined traumatic injury inducing condition is detected by a controller receiving a signal from the sensing means;
dispensing the neuro-protective drug from the body-mounted dispensing mechanism, which is operatively in communication with the controller, if the predetermined traumatic injury inducing condition is detected; and
continuing to monitor the environment if the predetermined traumatic injury inducing condition is not detected.

22. A method as set forth in claim 21 further including the step of remotely monitoring the individual within the environment.
